(19) United States
(12) Patent Application Publication
(10) Pub. No.: US 2002/0071127 A1
(43) Pub. Date: Jun. 13, 2002

(54) Positioning apparatus for probe card and TAB

(75) Inventors: Yukiyasu Takano, Tokyo (JP); Mitsuhiro Furuta, Tokyo (JP)

Correspondence Address: DARBY & DARBY P.C., 805 Third Avenue, New York, NY, 10022, US

(73) Assignee: Ando Electric Co., Ltd.

(21) Appl. No.: 10/010,218

(22) Filed: Dec. 4, 2001

(30) Foreign Application Priority Data
Dec. 13, 2000 (JP) 2000-379387

(51) Int. Cl. G01B 11/14

(52) U.S. Cl. 356/614

(57) ABSTRACT

The present invention provides a positioning apparatus in which the correction of discordance between the probe card and TAB can be performed easily and quickly. The positioning apparatus of the present invention comprises a probe card, TAB, arithmetic processing unit, and an automatic XY-moving mechanism. In the positioning apparatus, coordinates which denote a position of an optionally selected probe of the probe card and a position of a test pad of the TAB in which the probe is expected to make contact are entered into the arithmetic processing unit. The arithmetic processing unit automatically calculates corrective distances for contacting the test pad and probe, and outputs a signal corresponding to the corrective distances to the automatic XY-moving mechanism. The automatic XY-moving mechanism automatically moves the probe card toward the TAB in proportion to the corrective distances.

### BACKGROUND OF THE INVENTION

1. Field of the Invention

The present invention relates to a positioning apparatus for a probe card and TAB, and in particular, relates to a positioning apparatus for correcting the positional discordance along the X- and Y-axes between the probe card and TAB.

2. Description of the Related Art

As is generally known, heretofore, when the positional discordance along the X- and Y-axes between a probe card and TAB occurs, respective probes 2A of the probe card 2 (shown in FIG. 6) do not make contact with respective test pads 1C of the TAB 1 (shown in FIG. 5), so that the electric characteristics of the TAB 1 cannot be measured.

Consequently, the positional discordance along the X- and Y-axes between the probe card and TAB is corrected by a positioning apparatus as shown in FIG. 6. In FIG. 6, the probe card 2 having a plurality of probes 2A is mounted on a connecting ring 3 which is fastened on a XY-stage 4. The TAB 1 which has a plurality of test pads 1C as shown in FIG. 5 is provided on the prove card 2. Furthermore, a monitoring camera 6 which is mounted on a XY-stage 5 and connected with a monitoring display 8 is provided at directly under the XY-stage 4.

In a conventional positioning apparatus having the above structure, the positional discordance along the X- and Y-axes between the probe card 2 and TAB 1 is detected by watching the picture of the probe card 2 and TAB 1 which is taken by the monitoring camera 6 and projected onto the monitoring display 8.

When the positional discordance is detected, the discordance is corrected by manually rotating a knob 4D and moving the XY-stage 4 along the X-axis and by manually rotating a knob 4E and moving the XY-stage 4 along the Y-axis while watching the picture of the probe card 2 and TAB 1 on the monitoring display 8.

When the discordance is corrected, the TAB 1 is guided by sprockets 11, 12 and pulled down until test pads 1C of the TAB 1 make contact with corresponding probes 2A of the probe card 2, and the electric characteristics of the TAB 1 is measured by a test head (not shown in figure).

In the positioning apparatus, an accuracy of 50 μm and below is required for the correction of discordance along the X- and Y-axes between the probe card 2 and TAB 1 in accordance with the size of each test pad 1C and the whole length of the arranged test pads 1C (shown in FIG. 5). However, in the conventional positioning apparatus, since the positional discordance is manually corrected by rotating the knobs 4D, 4E under the control of visual observation, accurate positioning between the probe card 2 and TAB 1 cannot be performed. Furthermore, in a conventional positioning apparatus, since the positioning operation is manually performed, errors in the operation are liable to occur. Therefore, there are cases in which the operation has to be repeated until probes 2A are appropriately make contact with test pads 1C, so that it takes a long time to perform the correction.

### SUMMARY OF THE INVENTION

It is an object of the present invention to provide a positioning apparatus in which the correction of discordance along the X- and Y-axes between the probe card and TAB can be performed easily and quickly.

The positioning apparatus of the present invention comprises a probe card 2 having a plurality of probes 2A1, TAB 1 having a plurality of test pads 1C1, arithmetic processing unit 7, and an automatic XY-moving mechanism 10, as shown in FIG. 1A. In the positioning apparatus, a coordinate 5A which denotes a position of the optionally selected probe 2A1 and a coordinate 5B which denotes a position of the test pad 1C1 at which the selected probe 2A1 is expected to make contact are entered into the arithmetic processing unit 7 as shown in a signal S1 in FIG. 1. The arithmetic processing unit 7 automatically calculates corrective distances X and Y for contacting the test pad 1C1 and probe 2A1, and outputs a signal S23 corresponding to the corrective distances X and Y to the automatic XY-moving mechanism 10. Then, the automatic XY-moving mechanism 10 automatically moves the probe card 2 toward the TAB 1 in proportion to the corrective distances X and Y. As a result, the discordance between the probe card 2 and TAB 1 can be corrected easily and quickly.

### BRIEF EXPLANATION OF THE DRAWINGS

FIG. 1A is a schematic diagram of an example of the positioning apparatus of the present invention.

FIG. 1B is a schematic diagram for explaining the arithmetic processing unit shown in FIG. 1A.

FIG. 2 is an example of a flowchart for explaining the motion of the positioning apparatus of the present invention.

FIG. 3 is a diagram for explaining an example of the relation between the automatic XY-moving mechanism and probe card XY-stage of the positioning apparatus of the present invention.

FIG. 4A is a diagram for explaining an example of the process for positioning the probe card toward the TAB in the positioning apparatus of the present invention.

FIG. 4B is a diagram for explaining an example of the process for positioning the probe card toward the TAB in the positioning apparatus of the present invention.

FIG. 5 is a diagram for explaining an example of the structure of the TAB.

FIG. 6 is a schematic diagram of an example of conventional positioning apparatus.

### DESCRIPTION OF THE PREFERRED EMBODIMENTS

Preferred embodiments will be presented in the following with reference to the attached figures.

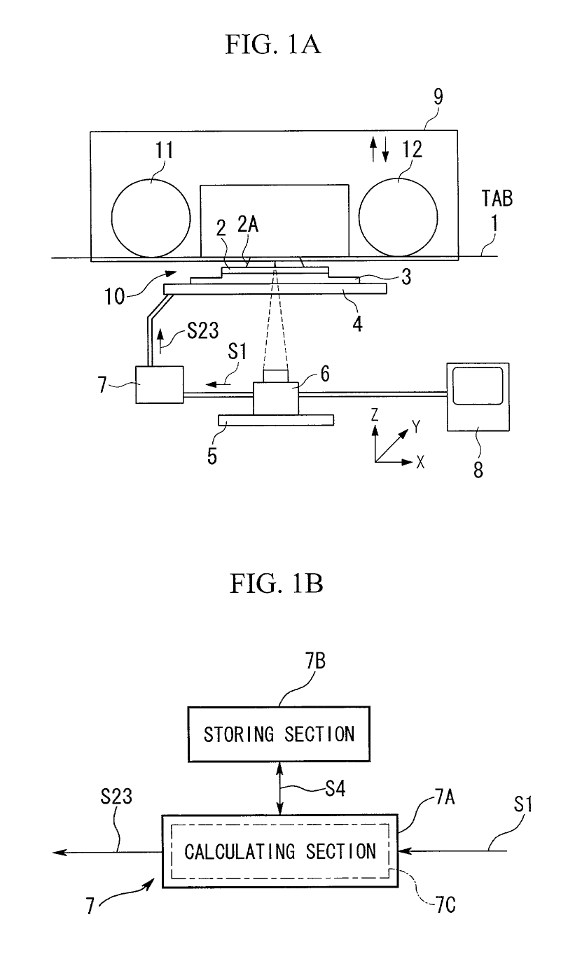

FIGS. 1A and 1B show an example of the positioning apparatus of the present invention.

FIG. 1A is a diagram for explaining an example of the positioning apparatus of the present invention which is applied to an automatic handler for TAB for automatically carrying the TAB which is wound by a reel to a measuring position and classifying the TAB in accordance with the result of the measurement using an IC tester.

In FIG. 1A, reference number 1 denotes the TAB, 2 denotes a probe card, 3 denotes a connecting ring, 4 denotes a probe card XY-stage, 5 denotes a monitoring camera XY-stage, 6 denotes a monitoring camera, 7 denotes an arithmetic processing unit, 8 denotes a monitoring display, 9 denotes an automatic XY-moving mechanism, and 11 and 12 denote sprockets.

The TAB 1 is one electric device and is composed of a plurality of IC chips 1B which are arranged on a tape-like film along the X-axis direction (longitudinal direction of the film), a plurality of test pads 1C which are arranged parallel to the arrangement direction of the IC chips so as to be located on both Y-axis sides of each IC chip 1B, a plurality of leads 1A which connect the IC chips and test pads 1C respectively, and a resist 1D which protects the IC chips 1B and leads 1A.

The TAB 1 is wound by a supply reel and a receiving reel (not shown in figure), and can be transferred along the X-axis direction guided by the sprockets 11, 12 which synchronously rotate. Furthermore, the TAB 1 can be put in contact with the below-mentioned probe card 2 by moving down the pusher 9, and can be separated from the probe card 2 by lifting up the pusher 9.

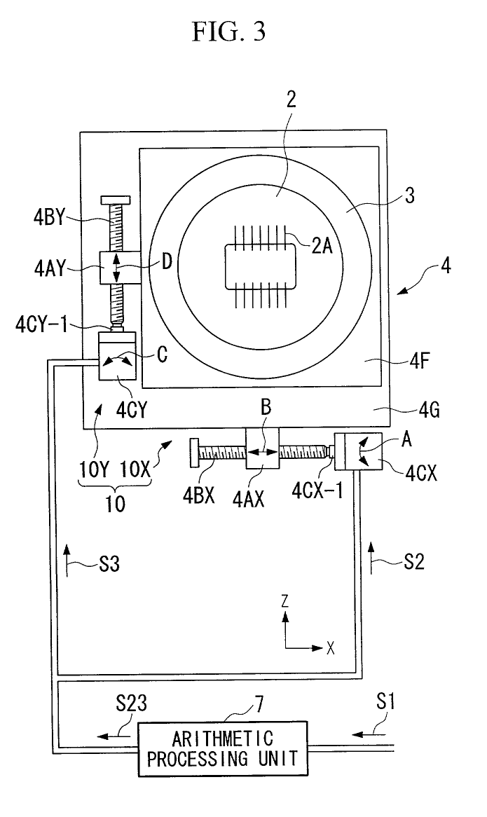

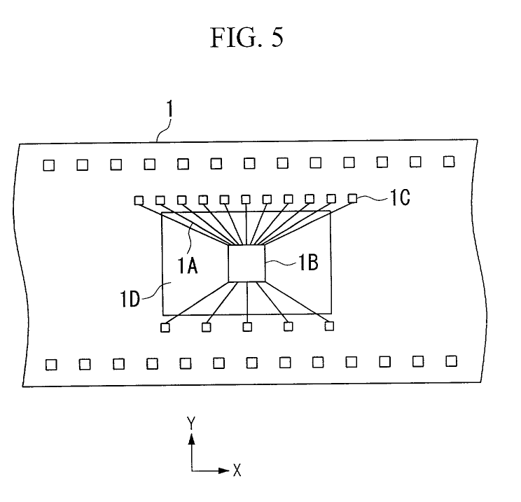

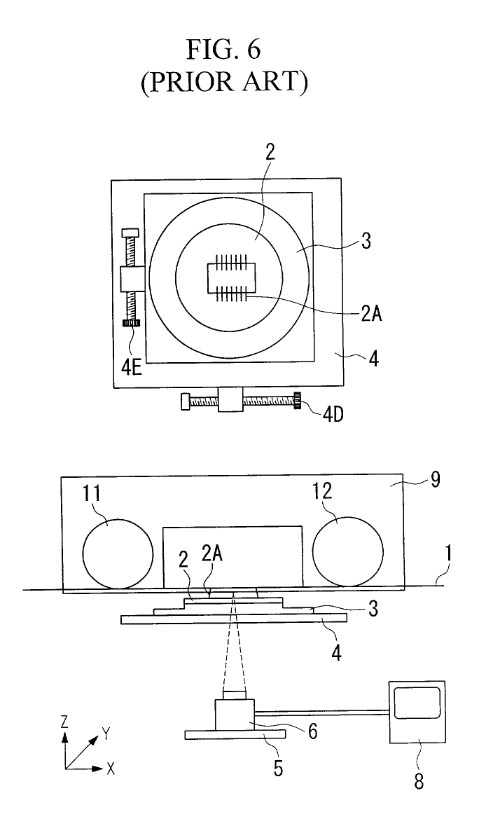

The probe card 2 has a circular printed circuit board as shown in FIG. 3, and a plurality of probes 2A are provided on the printed circuit board so as to make contact with the corresponding test pads 1C (shown in FIG. 5) of the TAB 1.

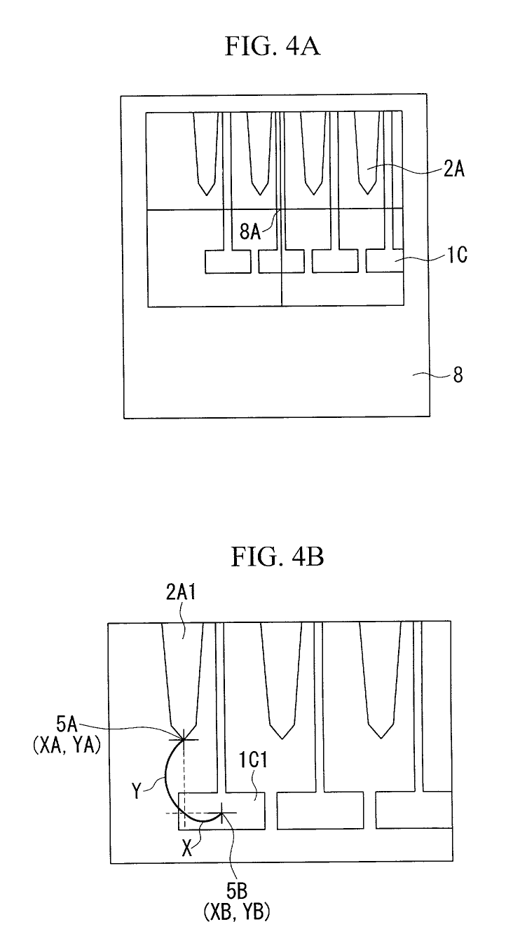

The probe card XY-stage 4 can be moved along the X- and Y-axes directions by the below-mentioned automatic XY-moving mechanism 10. The probe card XY-stage 4 is composed of a X-stage 4G and Y-stage 4F as shown in FIG. 3. The Y-stage 4F is fixed on the X-stage 4G and the connecting ring 3 is fixed on the Y-stage 4F, and the aforementioned probe card 2 is mounted on the connecting ring 3. Furthermore, the monitoring camera 6 which is mounted on the monitoring camera XY-stage 5 and connected with the monitoring display 8 is provided at directly under the probe card XY-stage 4 as shown in FIG. 1A. The monitoring camera XY-stage 5 is moved along the X- and Y-axes, and as described later, a coordinate 5A (XA, YA) which denotes a position of an optionally selected probe 2A1 and a coordinate 5B (XB, YB) which denotes a position of a test pad 1C1 at which the probe 2A1 is expected to make contact are entered into the arithmetic processing unit 7 as a signal S1 shown in FIGS. 1A, 1B and 3, by adjusting a target mark 8A (shown in FIG. 4A) projected on the picture of the monitoring display 8 with the probe 2A1 and test pad 1C1 respectively.

The signal S1 corresponding to the coordinates which denote the positions of the probe 2A1 and test pad 1C1 are stored in the arithmetic processing unit 7, and the after-mentioned corrective distances X and Y (see an after-mentioned equation (1)) are calculated by the arithmetic processing unit 7. Furthermore, the arithmetic processing unit 7 automatically controls the motions of all members which are disclosed in FIG. 1A.

The arithmetic processing unit 7 is composed of a calculating section 7A and storing section 7B as shown in FIG. 1B.

The calculating section 7A is composed of a CPU for example, and a corrective distance calculating program 7C for calculating the corrective distances X and Y based on the after-mentioned equation (1) is stored therein. Furthermore, the calculating section 7A outputs a signal S23 corresponding to the corrective distances X and Y to the automatic XY-moving mechanism 10.

The storing section 7B is composed of a RAM for example, and stores the coordinates 5A (XA, YA) and 5B (XB, YB). These coordinates 5A and 5B are used for the calculation of the corrective distances X and Y using the corrective distance calculating program 7C in the calculating section 7A (shown in a signal S4 in FIG. 1B).

The automatic XY-moving mechanism 10 is provided for moving the probe card 2 toward the TAB 1 in proportion to the corrective distances X and Y, in accordance with the signal S23 provided from the arithmetic processing unit 7. The automatic XY-moving mechanism 10 is composed of an X-moving mechanism 10X for moving the aforementioned X-stage 4G and a Y-moving mechanism 10Y for moving the aforementioned Y-stage 4F.

The X-moving mechanism 10X is composed of a pulse motor 4CX which is connected with the arithmetic processing unit 7, a ball screw 4BX which is combined with the pulse motor 4CX, and an engaging member 4AX which is engaged with the ball screw 4BX and combined with the X-stage 4G.

The Y-moving mechanism 10Y is composed of a pulse motor 4CY which is connected with the arithmetic processing unit 7, a ball screw 4BY which is combined with the pulse motor 4CY, and an engaging member 4AY which is engaged with the ball screw 4BY and combined with the Y-stage 4F.

The pulse motors 4CX, 4CY are motors which only rotate a predetermined angle in accordance with impressed pulsed voltage, and rotatory shafts 4CX-1, 4CY-1 thereof are respectively combined with the ball screws 4BX, 4BY.

In the automatic XY-moving mechanism 10 having the above-described structure, when a signal S2 corresponding to the corrective distances X along the X-axis direction and a signal S3 corresponding to the corrective distances Y along the Y-axis direction in the signal S23 from the arithmetic processing unit 7 are respectively inputted into the pulse motors 4CX, 4CY as the predetermined pulsed voltage, the pulse motors 4CX, 4CY only rotate the predetermined angle (as shown in allows A and C in FIG. 3) in accordance with the pulsed voltage. As a result, the ball screws 4BX, 4BY also rotate the predetermined angle and the engaging members 4AX, 4AY which are engaged with the ball screws 4BX, 4BY are respectively moved in proportion to the corrective distances X and Y (as shown by arrows B and D in FIG. 3).

When the engaging members 4AX, 4AY moves, the probe card XY-stage 4 which is composed of the X-stage 4G and Y-stage 4F, which are combined with the engaging members 4AX, 4AY, is moved in proportion to the corrective distances X and Y. Consequently, the discordance along the X- and Y-axes between the probes 2A and test pads 1C is corrected (as shown in FIG. 4B).

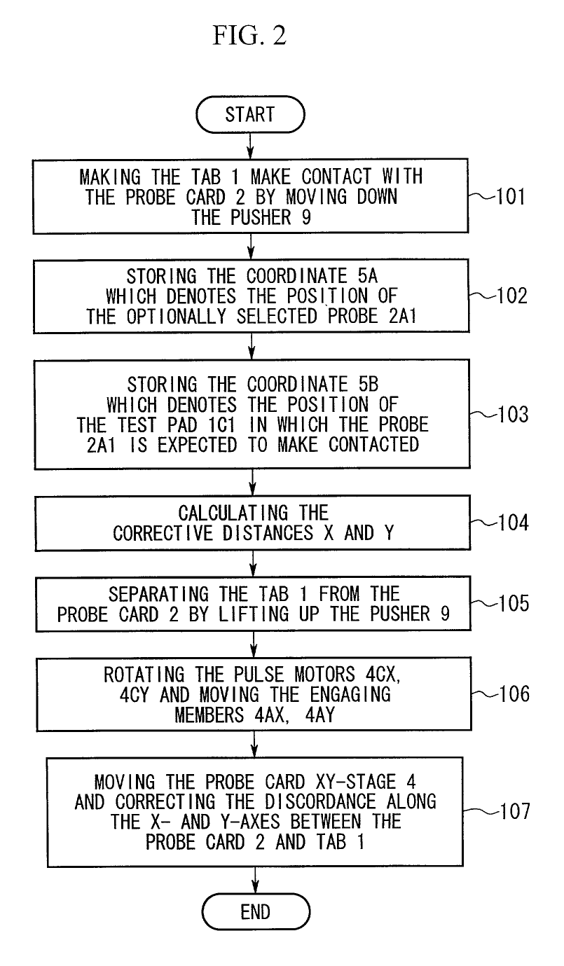

The following description is to explain the motion of the apparatus of the present invention having the above-described structure in conformity with a flowchart of FIG. 2. As mentioned above, all motions described in the flowchart are automatically controlled by the arithmetic processing unit 7.

First, in step 101 of FIG. 2, the TAB 1 makes contact with the probe card 2 by taking down the pusher 9, and an enlarged picture of the probes 2A and test pads 1C are projected onto the monitoring display 8 as shown in FIG. 4A.

Next, in step 102, the coordinate 5A (XA, YA) which denotes the position of the probe 2A1 optionally selected from the probes 2A is entered. In detail, the target mark 8A is adjusted to the tip of the probe 2A1 on the picture of the monitoring display 8 by moving the monitoring camera XY-stage 5, and a switch (not shown in the figure) is pushed. As a result, the coordinate 5A (XA, YA) which denotes the position of the probe 2A1 (shown in FIG. 4B) is entered into the arithmetic processing unit 7 as the signal S1, and stored into the storing section 7B of the arithmetic processing unit 7 (shown in FIGS. 1A and 1B).

Next, in step 103, the target mark 8A is adjusted to the center of the test pad 1C1 in which the probe 2A1 is expected to make contact on the picture of the monitoring display 8 by moving the monitoring camera XY-stage 5, and the coordinate 5B (XB, YB) which denotes the position of the test pad 1C1 (shown in FIG. 4B) is stored into the storing section 7B of the arithmetic processing unit 7 by a process similar to that as described above.

That is, by moving the monitoring camera XY-stage 5 on the picture of the monitoring display 8, the coordinate 5A which denotes the position of the optionally selected probe 2A1 and the coordinate 5B which denotes the position of the test pad 1C1 in which the probe 2A1 is expected to be contacted are respectively entered into the arithmetic processing unit 7.

Next, in step 104, the coordinates 5A and 5B corresponding to the positions of the probe 2A1 and test pad 1C1 which are stored into the storing section 7B are entered into the calculating section 7A of the arithmetic processing unit 7 (shown in the signal S4 in FIG. 1B). Then, the calculating section 7A calculates the corrective distances X and Y in accordance with the following equation (1).

X=XA−XB, Y=YA−YB (1)

When the calculation of the corrective distances X and Y is finished, the TAB 1 is separated from the probe card 2 by lifting up the pusher 9 in step 105. The reason for separating the TAB 1 from the probe card 2 is that if the TAB 1 is contacted with the probe card 2 during the correction of the distances X and Y, the probe 2A will be damaged and the following measurement of the electric characteristics of the TAB 1 by the test head (not shown in the figure) cannot be performed.

Next, in step 106, the signal S2 corresponding to the corrective distances X along the X-axis direction and the signal S3 corresponding to the corrective distances Y along the Y-axis direction in the signal S23 from the calculating section 7A of the arithmetic processing unit 7 are respectively inputted into the pulse motors 4CX, 4CY as the predetermined pulsed voltage, and the pulse motors 4CX, 4CY are rotated only to the predetermined angle (as shown by arrows A and C in FIG. 3) in accordance with the pulsed voltage. Then, the ball screws 4BX, 4BY are also rotated at the predetermined angle and the engaging members 4AX, 4AY which are engaged with the ball screws 4BX, 4BY are respectively moved in proportion to the corrective distances X and Y (as shown in allows B and D in FIG. 3).

When the engaging members 4AX, 4AY are moved, the probe card XY-stage 4 which is composed of the X-stage 4G and Y-stage 4F which are combined with the engaging members 4AX, 4AY is moved in proportion to the corrective distances X and Y in step 107, and the discordance along the X- and Y-axes between the probes 2A and test pads 1C is corrected (as shown in FIG. 4B).

As described above, according to the present invention, since the positioning device for the probe card and TAB comprises the arithmetic processing unit and the automatic XY-moving mechanism, the coordinates corresponding to the positions of the optionally selected probe and the test pad in which the probe is expected to make contact are automatically stored and the corrective distances for contacting the probe and test pad are automatically calculated from the coordinates, and the probe card is automatically moved toward the TAB in proportion to the corrective distances. Therefore, the discordance between the probe card and TAB can be corrected easily and quickly.

What is claimed is:

1. A positioning apparatus for probe card and TAB comprising:
a probe card having a plurality of probes, and mounted on a probe card XY-stage which can be moved along X- and Y-axes;
a TAB having a plurality of test pads in which said probes are expected to make contact respectively;
an arithmetic processing unit which stores coordinates which denote positions of a probe optionally selected from said probes and the test pad in which said probe is expected to make contact, and calculates corrective distances along the X- and Y-axes for bringing said test pad and probe into contact; and
an automatic XY-moving mechanism which is connected with the arithmetic processing unit and said probe card XY-stage, and moves said probe card toward said TAB in proportion to said corrective distances which are provided from said arithmetic processing unit as a signal corresponding to said corrective distances.

2. A positioning apparatus for probe card and TAB according to claim 1, wherein said arithmetic processing unit is composed of a storing section which stores said coordinates and a calculating section which stores a corrective distance calculating program for calculating said corrective distances.

3. A positioning apparatus for probe card and TAB according to claim 1, wherein said probe card XY-stage is composed of an X-stage and a Y-stage, and said automatic XY-moving mechanism is composed of an X-moving mechanism for moving the X-stage and a Y-moving mechanism for moving the Y-stage.

4. A positioning apparatus for probe card and TAB according to claim 3, wherein said X-moving mechanism is composed of a pulse motor which is connected with said arithmetic processing unit, a ball screw which is combined with the pulse motor, and an engaging member which is engaged with said ball screw and combined with said X-stage; and said Y-moving mechanism is composed of a pulse motor which is connected with said arithmetic processing unit, a ball screw which is combined with the pulse motor, and an engaging member which is engaged with said ball screw and combined with said Y-stage.
